(19) United States
(12) Patent Application Publication
(10) Pub. No.: US 2006/0145595 A1
(43) Pub. Date: Jul. 6, 2006

(54) Image display device

(76) Inventors: Hae-Su Youn, Suwon-si (KR); Soon-Cheol Shin, Suwon-si (KR); Joon-Soo Bae, Suwon-si (KR); Hyun-Chul Ji, Suwon-si (KR); Won-Bok Lee, Suwon-si (KR); Hyuck-Keun Oh, Suwon-si (KR); Seung-Hee Jeong, Suwon-si (KR); Chang-Ryon Byon, Suwon-si (KR); Kuen-Dong Ha, Suwon-si (KR); Jong-Hoon Lim, Suwon-si (KR); Hideki Miyazaki, Suwon-si (KR)

Correspondence Address: CHRISTIE, PARKER & HALE, LLP, PO BOX 7068, PASADENA, CA, 91109-7068, US

(21) Appl. No.: 11/291,527

(22) Filed: Nov. 30, 2005

(30) Foreign Application Priority Data
Nov. 30, 2004 (KR) 10-2004-0099544
Feb. 28, 2005 (KR) 10-2005-0016835
Nov. 22, 2005 (KR) 10-2005-0111642
Nov. 22, 2005 (KR) 10-2005-0111693

(51) Int. Cl. H01J 63/04; H01J 1/62

(52) U.S. Cl. 313/496

(57) ABSTRACT

An image display device where in the region of electron emission regions and the region of phosphor layers are spaced apart from each other with a predetermined distance therebetween without mounting spacers therein. The image display device includes a vacuum vessel having a first substrate, a second substrate placed to face a first side of the first substrate to form a first region together with the first substrate, and a reinforcing member placed to face a second side of the first substrate to form a second region together with the first substrate. An electron emission unit is formed on a surface of the first substrate, and a light emission unit is formed on a surface of the second substrate. The first substrate has one or more through-holes for coupling the first and second regions with each other.

### CROSS-REFERENCE TO RELATED APPLICATIONS

This application claims priority to and the benefit of Korean Patent Application Nos. 10-2004-0099544, filed on Nov. 30, 2004, 10-2005-0016835, filed on Feb. 28, 2005, 10-2005-0111642, filed on Nov. 22, 2005, and 10-2005-0111693, filed on Nov. 22, 2005, in the Korean Intellectual Property Office, the entire contents of which are incorporated herein by reference.

### BACKGROUND OF THE INVENTION

1. Field of the Invention

The present invention relates to an image display device, and in particular, to an image display device which has a vacuum chamber (or a vacuum vessel) capable of spacing electron emission regions away from phosphor layers with a predetermined distance therebetween without mounting spacers therein.

2. Description of Related Art

Generally, an image display device using electrons to emit light has a vacuum chamber (or a vacuum vessel) with electron emission regions and phosphor layers. The electrons emitted from the electron emission regions excite the phosphor layers, thereby emitting light or displaying the desired images.

Depending upon the shape of the vacuum vessel, the image display devices are classified into a type using a bulb vacuum vessel, such as a cathode ray tube (CRT) display device, and a type using a flat panel vacuum vessel with front and rear substrates and a sealing member, such as a vacuum fluorescent display (VFD) device and a field emitter array (FEA) electron emission display device.

With the image display device using the flat panel vacuum vessel, the larger the screen size and/or the higher the internal vacuum degree of the vacuum vessel are, the greater the pressure compressed thereto becomes. Accordingly, it has been proposed that a plurality of spacers should be mounted within the vacuum vessel to prevent it from being distorted and broken. In this case, the spacers are located to correspond to black layers disposed between the phosphor layers such that they do not intrude into the area of the phosphor layers.

However, as the display devices become higher in resolution, the width of the black layers where the spacers are located becomes narrower, and correspondingly, spacers with a minute size and a high aspect ratio are needed. However, it is complicated to manufacture spacers satisfying such a condition, and it is difficult to attach these thousands of minute spacers on the front or the rear substrates.

Furthermore, with the conventional image display device, the initial vacuum degree is not heightened due to the spacers, and a failure in mounting the spacers is liable to be made during the exhausting process. That is, if the image display device does not initially achieve a high vacuum state, the vacuum degree may gradually be lowered due to the outgassing of the members built in the vacuum vessel such that the display characteristic may become deteriorated, and the mount-failed spacers may block the trajectories of the electron beams, thereby deteriorating the screen image quality.

Moreover, the spacers formed with a dielectric material such as glass, ceramic, etc., may be struck with electrons at the surface thereof during the operation of the display device, and may then be surface-charged into a positive or negative potential. The charged spacers attract or repulse the electrons passing therearound, thereby distorting the trajectories of the electron beams, and deteriorating the display quality.

As such, spacers are effective in stabilizing the flat panel vacuum vessel, but they lower the productivity of the image display device and deteriorate the screen image quality.

### SUMMARY OF THE INVENTION

In one exemplary embodiment of the present invention, there is provided an image display device that forms a stable vacuum vessel without mounting spacers therein, and/or minimizes a deterioration in the vacuum degree of the vacuum vessel due to outgassing by heightening the initial vacuum degree of the vacuum vessel.

In an exemplary embodiment of the present invention, the image display device includes a vacuum vessel having electron emission regions and phosphor layers for emitting light due to electrons emitted from the electron emission regions. A substrate traverses an interior of the vacuum vessel to partition the interior of the vacuum vessel into a plurality of regions. The substrate has a through-hole for coupling the plurality of regions with each other.

The plurality of regions may have respective volumes differing from each other.

The plurality of regions partitioned by the substrate may include a first region including the electron emission regions and the phosphor layers, and a second region coupled with the first region via the through-hole.

The electron emission regions and the phosphor layers may be spaced apart from each other with a distance from about 1.8 to about 10 mm. An evaporative getter may be provided at the second region.

In another exemplary embodiment of the present invention, the image display device includes a vacuum vessel having a first substrate, a second substrate placed to face a first side of the first substrate to form a first region together with the first substrate, and a reinforcing member placed to face a second side of the first substrate to form a second region together with the first substrate. An electron emission unit is formed on a surface of the first substrate. A light emission unit is formed on a surface of the second substrate. The first substrate has one or more through-holes for coupling the first and second regions with each other.

The second substrate and the reinforcing member may be thicker than the first substrate.

The reinforcing member may have a convex central portion facing the first substrate, and a concave body portion externally surrounding the central portion and facing the first substrate. The second region may have a volume larger than the first region.

Alternatively, the reinforcing member may have a third substrate placed parallel to the first substrate, and a support frame disposed between the first and third substrates and attached thereto.

Alternatively, the reinforcing member may have a flat panel portion placed parallel to the first substrate, and a skirt portion extended from a periphery of the flat panel portion to the first substrate.

Alternatively, the reinforcing member may have a substantially flat outline, and include a concave portion and a sidewall formed on a surface thereof facing the first substrate. The sidewall may occupy about 50% to about 90% of the entire surface area of a surface of the reinforcing member facing the first substrate with a width that varies along a periphery of the reinforcing member.

The first and second substrates may be spaced apart from each other with a distance from about 1.8 to about 10 mm. The electron emission unit may have electron emission regions having cold cathode electron sources.

### BRIEF DESCRIPTION OF THE DRAWINGS

FIG. 1 is a front perspective view of an image display device according to a first embodiment of the present invention.

FIG. 2 is a rear perspective view of the image display device according to the first embodiment of the present invention.

FIG. 3 is a sectional view of the image display device taken along the I-I line of FIG. 2.

FIG. 4 is a sectional view of the image display device according to the first embodiment of the present invention taken along the I-I line of FIG. 2, and illustrating display and non-display areas thereof.

FIG. 5 is a sectional view of the image display device according to the first embodiment of the present invention taken along the I-I line of FIG. 2, and illustrating a getter activating process.

FIG. 6 is a sectional view of an image display device according to a second embodiment of the present invention.

FIG. 7 is a sectional view of an image display device according to a third embodiment of the present invention.

FIG. 8 is an exploded perspective view of an image display device according to a fourth embodiment of the present invention.

FIG. 9 is a sectional view of the image display device taken along the II-II line of FIG. 8.

FIG. 10 is a plan view of a reinforcing member shown in FIG. 8.

FIG. 11 is a perspective view of an image display device according to a fifth embodiment of the present invention.

FIG. 12 is a sectional view of the image display device taken along the III-III line of FIG. 11.

FIG. 13 is a partial sectional view of an image display device according to a sixth embodiment of the present invention.

FIG. 14 is a partial amplified view of the image display device shown in FIG. 13.

FIG. 15 is a partial exploded perspective view of first and second substrates of an image display device according to an embodiment of the present invention, and applied to a field emitter array electron emission display device.

FIG. 16 is a partial sectional view of the first and second substrates of the image display device shown in FIG. 15.

### DETAILED DESCRIPTION

The present invention will be described more fully hereinafter with reference to the accompanying drawings, in which examples of embodiments of the invention are shown.

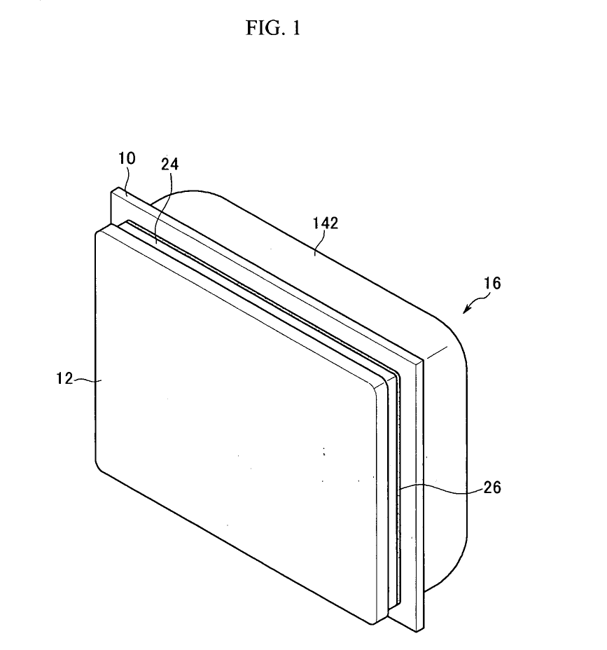

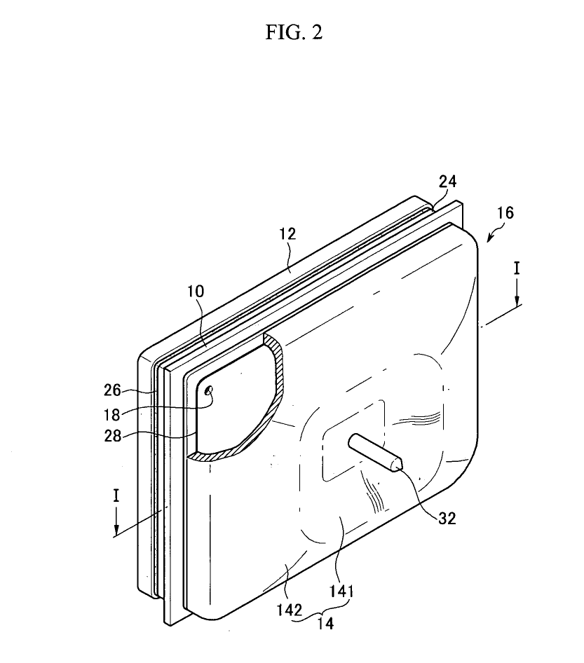

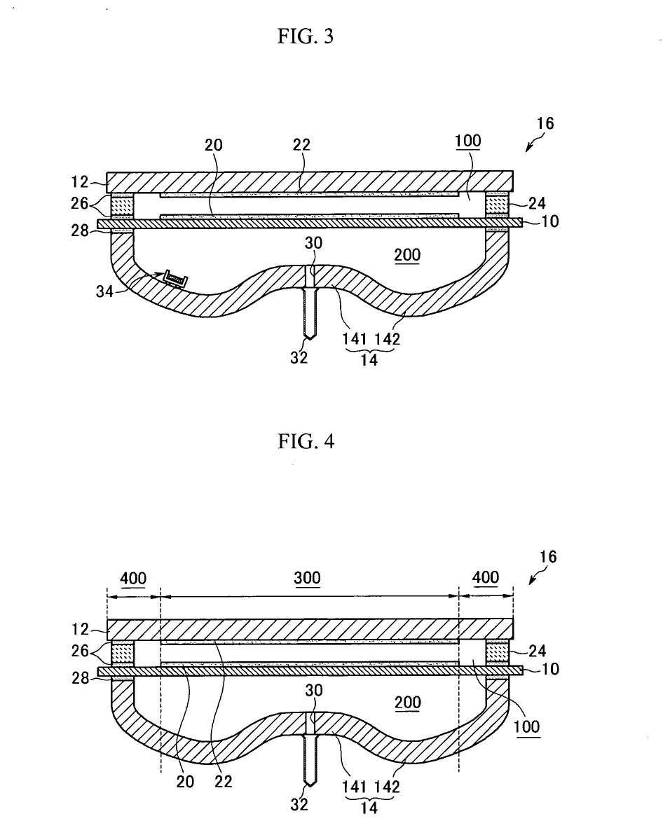

As shown in FIGS. 1 to 3, an image display device according to a first embodiment of the present invention is formed with a vacuum chamber (or a vacuum vessel) 16. The vacuum vessel 16 includes first and second substrates 10 and 12 facing each other while interposing a first region 100 therebetween, and a reinforcing member 14 attached to the rear of the first substrate 10 while forming a second region 200 together with the first substrate 10.

The first and second regions 100 and 200 refer to the spatial regions that are divided by the first substrate 10 within the vacuum vessel 16. One or more through-holes 18 are formed at the first substrate 10 to couple the first and second regions 100 and 200 with each other.

More specifically, an electron emission unit 20 is provided on a surface of the first substrate 10 facing the second substrate 12 to emit electrons toward the second substrate 12. The first substrate 10 functions as a cathode substrate together with the electron emission unit 20. A light emission unit 22 is provided on a surface of the second substrate 12 facing the first substrate 10 to emit visible rays (or light) due to the electrons. The second substrate 12 functions as an anode substrate together with the light emission unit 22.

A support frame 24 is placed at the peripheries of the first and second substrates 10 and 12. A first adhesive layer 26 is disposed between the first substrate 10 and the support frame 24 as well as between the second substrate 12 and the support frame 24 to attach the first substrate 10, the support frame 24, and the second substrate 12 to each other as a body.

Accordingly, the first region 100 is surrounded by the first and second substrates 10 and 12 and the support frame 24, and the distance between the first and second substrates 10 and 12 is determined by the height of the support frame 24. The support frame 24 may be formed with the same material as that for the first and second substrates 10 and 12, or a material having a thermal expansion coefficient similar to that of the first and second substrates 10 and 12.

In one embodiment, the second substrate 12 is formed with a thickness large enough to endure the vacuum compression pressure, for instance with a thickness of 10 mm or more. By contrast, since no vacuum compression pressure is applied to the first substrate 10 traversing the interior of the vacuum vessel 16, the first substrate 10 may be properly formed with a thickness smaller than that of the second substrate 12, for instance with a thickness of 5 mm or less.

The first substrate 10 is a substrate with electron emission regions and various kinds of suitable electrodes for controlling the emission of electrons from the electron emission regions. The first substrate 10 is heat-treated at high temperature several times during the process of forming the electron emission regions, the electrodes, and insulating layers for insulating the electrodes from each other. In this case, the first substrate 10 with the thickness of 5 mm or less only suffers a low thermal stress even under the radical temperature variation, and is prevented from being broken. This case also enhances the formation quality of the electron emission unit 20.

The reinforcing member 14 is attached to the rear of the first substrate 10 while forming a part of the outline of the vacuum vessel 16. In FIGS. 1 to 3, reference numeral 28 refers to a second adhesive layer for attaching the first substrate 10 to the reinforcing member 14. In consideration of the vacuum compression pressure, the reinforcing member 14 also has a thickness larger than that of the first substrate 10. For instance, the reinforcing member 14 may have the same thickness as the second substrate 12. An exhaust hole 30 and an exhaust tube 32 for evacuating the gas in the vessel 16, and a getter 34 for adsorbing the gas remaining after the evacuation process, are provided at the reinforcing member 14.

In this embodiment, the reinforcing member 14 has two or more portions having opposite curves (or curved opposite to each other); that is, the reinforcing member 14 has a concave portion facing the first substrate 10 and a convex portion facing the first substrate 10. More specifically, the reinforcing member 14 has a convex central portion 141 facing the first substrate 10, and a concave body portion 142 facing the first substrate 10 external to the convex central portion 141.

With the above-shaped reinforcing member 14, the volume of the second region 200 is formed to be significantly larger than that of the first region 100 due to the concave curvature of the body portion 142 toward the first substrate 10, and the depth of the vacuum vessel 16 is prevented from being enlarged due to the convex curvature of the central portion 141 toward the first substrate 10.

Furthermore, the above-shaped reinforcing member 14 effectively diffuses the stress made due to the vacuum compression pressure, and serves to stabilize the vacuum vessel 16. The exhaust tube 32 may be placed at the center of the central portion 141 of the reinforcing member 14 to minimize the depth of the vacuum vessel 16, and the getter 34 may be placed at the body portion 142 of the reinforcing member 14.

As the internal volume of the vacuum vessel 16 is enlarged with the formation of the first and second regions 100 and 200 therein, the distance between the first and second substrates 10 and 12 can be maintained constantly without mounting spacers at the first region 100 with the electron emission unit 20 and the light emission unit 22, thereby securing a stabilized structure.

That is, as shown in FIG. 4, when the vacuum vessel 16 is viewed from the front side, the region of the electron emission unit 20 and the light emission unit 22 provided to practically emit electrons and visible rays is the display region 300, and the region externally surrounding the display region 300 is the non-display region 400. In this embodiment, the first and second substrates 10 and 12 and the reinforcing member 14 are separately placed at the display region 300 along the depth of the vacuum vessel 16 without interposing any connection structures such as spacers therebetween, and only with an inner vacuum space therebetween.

Furthermore, in this embodiment, the initial vacuum degree of the vacuum vessel 16 may be heightened up to 10⁻⁶ Torr or more due to the enlarged internal volume thereof. With the heightening of the initial vacuum degree, even if an outgassing is made at the members constructing the electron emission unit 20 and/or the light emission unit 22 during the operation of the display device and the vacuum degree is lowered, the vacuum state is prevented from being too deteriorated due to the high initial vacuum degree.

In consideration of the lowering of the vacuum degree due to the outgassing, the second region 200 of an embodiment of the present invention should bear a volume larger than the first region 200. For instance, the second region 200 may be formed with a volume larger than the first region 100 by two or more times. The volume enlargement ratio of the second region 200 to the first region 100 is inversely proportional to the reduction rate in the vacuum degree due to the outgassing. That is, in a case in which the volume of the second region 200 is three times larger than that of the first region 100, the reduction rate in the vacuum degree due to the outgassing is roughly only ⅓ as much as compared with a case where the vacuum vessel 16 is provided only with the first region 100.

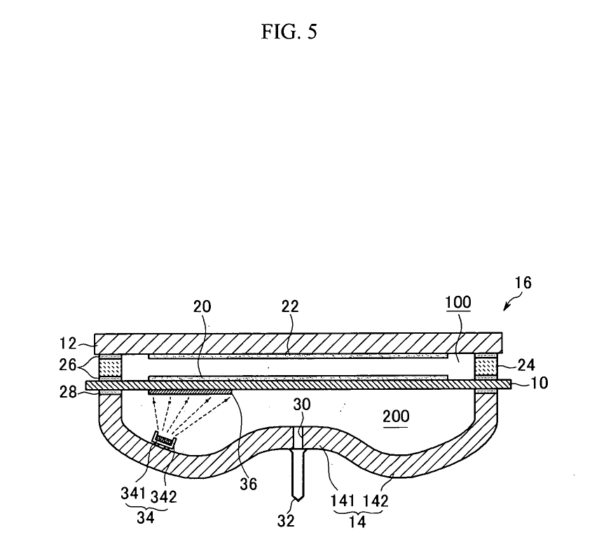

Furthermore, in this embodiment, the getter 34 may be formed with an evaporative getter. As shown in FIG. 5, the evaporative getter 34 includes an active metal 341 such as barium, magnesium, etc.; and a getter receptacle 342 containing the active metal 341. The getter receptacle 342 is heated using a high frequency induction heater (not shown) provided external to the reinforcing member 14, and the active metal 341 is diffused due to the heat to thereby form a getter film 36 and chemically adsorb and remove the gas remaining within the vacuum vessel 16.

In one embodiment, the getter film 36 is a conductive film, and it may be difficult to properly apply the evaporative getter 34 to a vacuum vessel with only a single region (with, for example, having only the first region 100 and not the region 200). However, with the vacuum vessel 16 according to the present embodiment, the second region 200 is formed at the rear of the first substrate 10, and hence, the evaporative getter 34 can be provided at the interior of the reinforcing member 14. The getter film 36 deposited on the rear surface of the first substrate 10 does not affect the electron emission unit 20 and the light emission unit 22 placed at the first region 100.

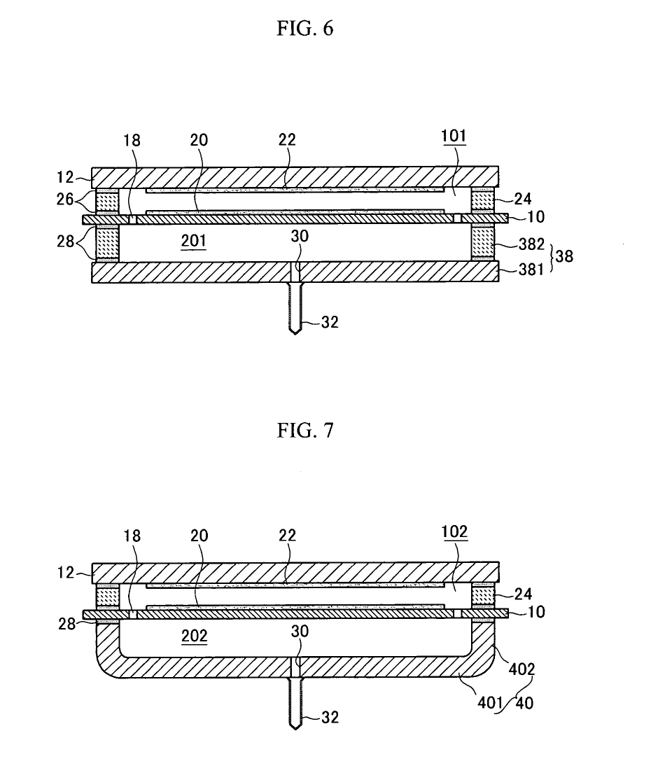

As shown in FIG. 6, with an image display device according to a second embodiment of the present invention, a reinforcing member 38 includes a third substrate 381 spaced apart from the rear surface of the first substrate 10 with a predetermined distance while proceeding parallel thereto, and a support frame 382 placed at the peripheries of the first and third substrates 10 and 381 to form a second region 201 together with the first and third substrates 10 and 381. In FIG. 6, reference numeral 28 refers to a second adhesive layer for attaching the first and third substrates 10 and 381 to the support frame 382 in a body.

For explanatory convenience, the support frame 24 disposed between the first and second substrates 10 and 12 is called the first support frame, and the support frame 382 disposed between the first and third substrates 10 and 381 is called the second support frame.

The second support frame 382 has a height greater than the first support frame 24 such that the second region 201 can bear a volume larger than a first region 101. In one embodiment, the second support frame 382 has a height that is high enough such that the second region 201 can bear a volume larger than the first region 101 by two or more times. Furthermore, the third substrate 381 has a thickness larger than the first substrate 10. For instance, the third substrate 381 may have the same thickness as the second substrate 12.

As shown in FIG. 7, with an image display device according to a third embodiment of the present invention, a reinforcing member 40 has a flat panel portion 401 spaced apart from the rear surface of the first substrate 10 with a predetermined distance while proceeding parallel thereto, and a skirt portion 402 vertically extended from the periphery of the flat panel portion 401 toward the first substrate 10, thereby forming a second region 202 therein together with the flat panel portion 401.

The skirt portion 402 has a height greater than the support frame 24 disposed between the first and second substrates 10 and 12 such that the second region 202 has a volume larger than a first region 102. In one embodiment, the skirt portion 402 has a height that is high enough such that the second region 202 can bear a volume larger than the first region 102 by two or more times.

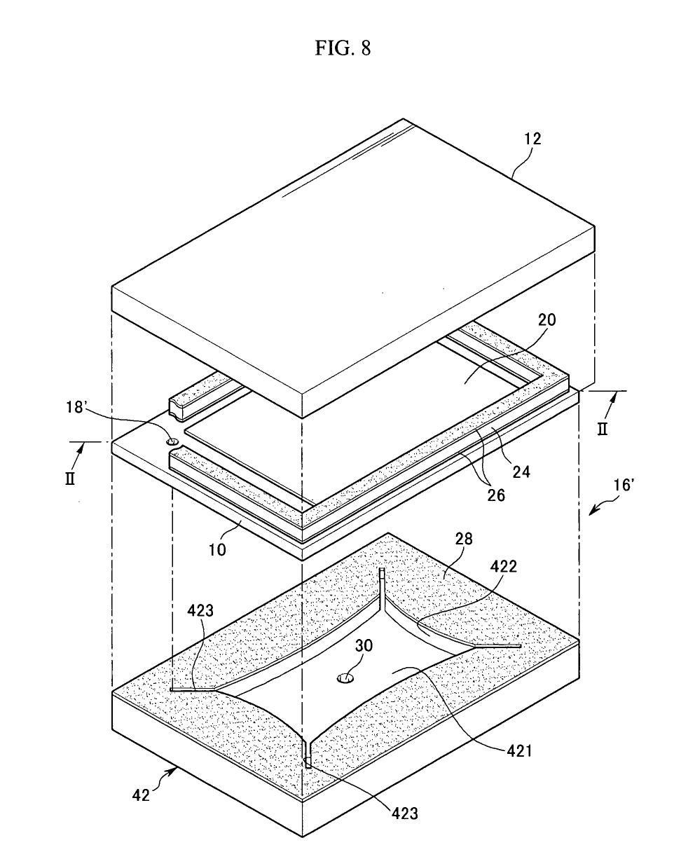

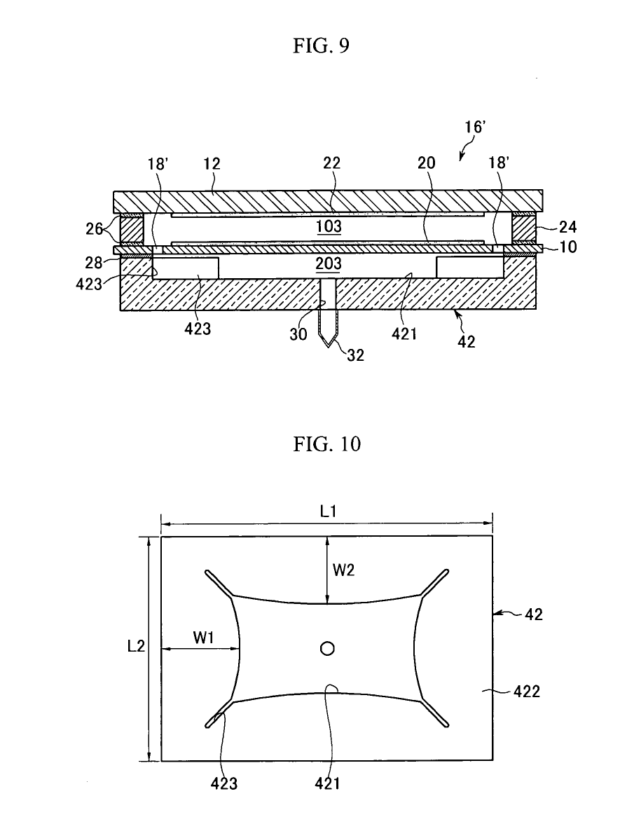

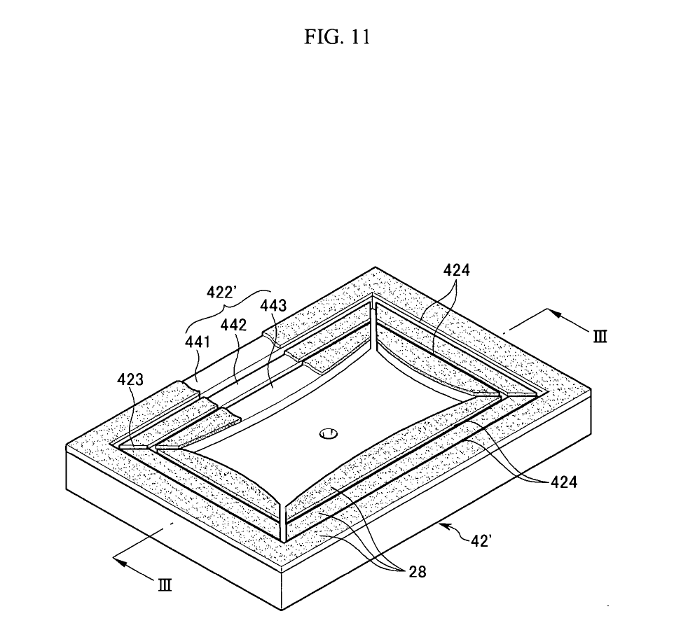

As shown in FIGS. 8 to 10, with an image display device according to a fourth embodiment of the present invention, a reinforcing member 42 is outlined to have a shape that is similar to a flat panel. However, the reinforcing member 42 also includes a concave portion 421 formed at the surface of the reinforcing member 42 facing the first substrate 10, thereby forming a second region 203 such that it is surrounded by the first substrate 10 and the reinforcing member 42.

In this embodiment, a vacuum vessel 16′ has a reinforcing member 42 installed at the rear of the first substrate 10 such that any connection structures such as spacers are excluded from a first region 103 with the electron emission unit 20 and the light emission unit 22. The vacuum vessel 16′ has an internal volume smaller than the vacuum vessels of the first to third embodiments such that this embodiment is more explosion proof.

The portion of the reinforcing member 42 facing the first substrate 10 except for the concave portion 421 thereof is referred to as the sidewall 422. In this embodiment, a second adhesive layer 28 is formed on a surface of the sidewall 422 facing the first substrate 10 to attach the reinforcing member 42 to the first substrate 10. The concave portion 421 formed at the reinforcing member 42 has predetermined width and depths corresponding to the volume of the second region 203 required for excluding the spacers.

More specifically, the sidewall 422 has a width that is larger than the support frame 24 disposed between the first and second substrates 10 and 12. When the surface of the reinforcing member 42 facing the first substrate 10 is assumed to have a surface area of 100%, the sidewall 422 may be established to occupy 50% to 90% of that surface area. The depth of the concave portion 421 has a depth that is deep enough for the reinforcing member 42 to bear a thickness larger than the first substrate 10.

Furthermore, in consideration of the distribution of the stress applied to the reinforcing member 42, it is established that the sidewall 422 has a maximum width at the centers of the long and short sides applied with a relatively high stress, and a minimum width at the diagonal comers applied with a relatively weak stress. With this structure, the area of the second adhesive layer 28 coated along the reinforcing member 42 is varied such that the regional stress differences of the reinforcing member 42 can be reduced.

Particularly, the sidewall 422 has a width gradually reduced (or gradually sloped) from the centers of the long and short sides of the reinforcing member 42 toward the diagonal comers thereof. With the slow width variation, the radical intensity variation made along the peripheries of the first substrate 10 and the reinforcing member 42 is prevented (or reduced), and the stress distribution of the first substrate 10 and the reinforcing member 42 is uniformly made.

For instance, the width W1 of the sidewall 422 measured at the center of the short side of the reinforcing member 42 may be established to be roughly 0.2 to 0.4 times larger than the length L1 of the long side of the reinforcing member 42. The width W2 of the sidewall 422 measured at the center of the long side of the reinforcing member 42 may be also established to be roughly 0.2 to 0.4 times larger than the length L2 of the short side of the reinforcing member 42.

When the sidewall 422 is established to occupy 50% to 90% of that surface area of the entire reinforcing member 42 facing the first substrate 10 and established with the previously-described width condition, the second region 203 may have a volume required for excluding the spacers, and the contact area between the reinforcing member 42 and the first substrate 10 may be enlarged, thereby securing the adhesion therebetween.

Also, through-holes 18′ are formed at the first substrate 10 external to the electron emission unit 20, for instance, at the diagonal comers of the first substrate 10. The through-holes 18′ correspond not to the concave portion 421 but to the sidewall 422 due to the shape of the reinforcing member 42 described above. In this embodiment, the reinforcing member 42 has communication grooves 423 extended from the portions of the sidewall 422 corresponding to the through-holes 18′ toward the concave portion 421. The first and second regions 103 and 203 couple (or communicate) with each other via the through-holes 18′ and the communication grooves 423.

As the reinforcing member 42 is outlined to have the shape that is similar to the flat panel, when the vacuum vessel 16′ is broken under the application of an external impact, the diffusion of the broken glass pieces to the outside of the vacuum vessel 16′ is minimized, thereby reducing the possibility of injuries to a user due to the broken glass pieces. Furthermore, the depth of the vacuum vessel 16′ is reduced to flatten the vacuum vessel 16′ (i.e., to make the vacuum vessel more flat), and the adhesion between the first substrate 10 and the reinforcing member 42 is secured. The second region 203 may be formed with a volume that is smaller than the first region 103. The width and depths of the concave portion 421 may also be controlled such that the second region 203 has a volume that is larger than the first region 103.

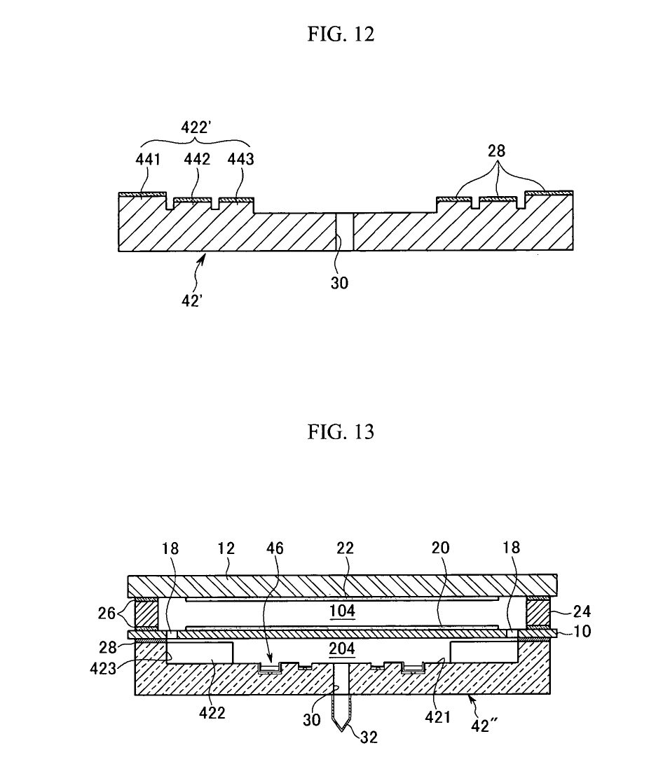

As shown in FIGS. 11 and 12, an image display device according to a fifth embodiment of the present invention has the structural components of the image display device related to the fourth embodiment except that partition grooves 424 are formed at the sidewall 422′ of the reinforcing member 42′. That is, in this embodiment, partition grooves 424 are formed at the surface of the sidewall 422′ of the reinforcing member 42′ facing the first substrate to partition the sidewall 422′ into two or more portions in the direction proceeding toward the central portion of the reinforcing member 42′, in addition to the communication grooves 423.

As shown in FIGS. 11 and 12, a pair of partition grooves (or holes) 424 may partition the sidewall 422′ formed at the long side of the reinforcing member 42′ parallel thereto into three portions, and a pair of partition grooves 424 may partition the sidewall 422′ formed at the short side of the reinforcing member 42′ parallel thereto into three portions.

The portions of the sidewall 422′ partitioned by the partition grooves 424 include a first sidewall 441, a second sidewall 442, and a third sidewall 443 sequentially formed from the outermost portion thereof. In addition, second adhesive layers 28 are formed on the respective top surfaces of the first to third sidewalls 441, 442, and 443 facing the first substrate, and the first sidewall 441 form a looped curve along the periphery of the reinforcing member 42′, thereby preventing the vacuum leakage.

The partition grooves 424 enhance discharge of the gas from the second adhesive layer 28 during the sealing by the second adhesive layer 28, and effectively serve as the vacuum vessel to achieve a high vacuum state. With the above structure, as shown in FIG. 12, the second and third sidewalls 442 and 443 may have a height lower than the first sidewall 441 such that the first sidewall 441 is tightly adhered to the first substrate without making any gaps, thereby preventing the vacuum leakage.

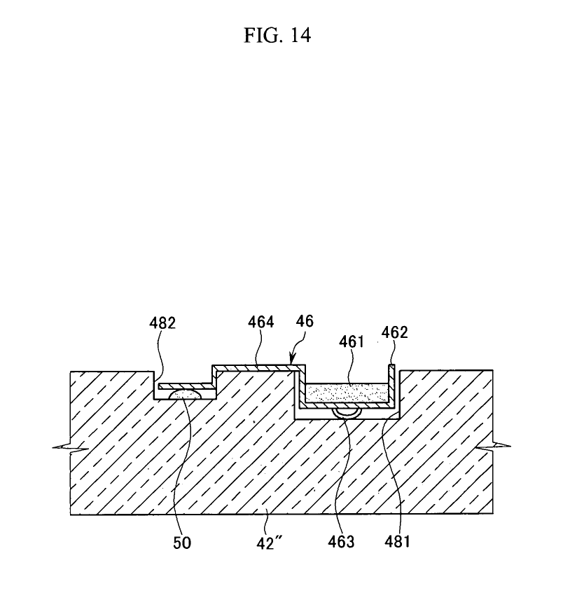

As shown in FIGS. 13 and 14, an image display device according to a sixth embodiment has a reinforcing member 42″ outlined to have a shape that is similar to a flat panel as like in the structure according to the fourth and/or fifth embodiment. In addition, the image display of FIGS. 13 and 14 is shown to have at least one evaporative getter 46 is mounted within the reinforcing member 42″.

In this embodiment, the evaporative getter 46 includes an active metal 461 such as barium, magnesium, etc.; a getter receptacle 462 containing the active metal 461; a contact spring 463 placed at the bottom of the getter receptacle 462; and a support 464 connected to the lateral side of the getter receptacle 462. The reinforcing member 42″ has a concave portion 421 with a first groove 481 accommodating the getter receptacle 462 and the contact spring 463, and a second groove 482 receiving the end of the support 464 such that the support 464 can be solidly fixed to the reinforcing member 42″.

The getter receptacle 464 is heated up to 900° C. or more during the process of heating and activating the active metal 461, and the contact spring 463 disposed between the getter receptacle 462 and the reinforcing member 42″ prevents the reinforcing member 42″ from being damaged due to the heat. An end of the support 464 is bent along the outline of the second groove 482, and attached to the reinforcing member 42″ using an adhesive layer, for example, a frit layer 50, such that the evaporative getter 46 can be solidly fixed to the reinforcing member 42″.

As the reinforcing member 42″ has the first and second grooves 481 and 482 while mounting the evaporative getter 46 therein, the second region 204 can be narrowed, and the active metal 461 can be effectively diffused, thereby enhancing the remnant gas adsorption efficiency. The concave portion 421 may bear a depth from 2 to 30 mm.

The vacuum vessels according to the previous embodiments of the present invention can be adapted to the image display devices using a cold cathode as an electron source, such as electron emission display devices being of a field emitter array (FEA) type, a surface conduction emission (SCE) type, a metal-insulator-metal (MIM) type, and a metal-insulator-semiconductor (MIS) type. A case where the vacuum vessel described above is applied to the FEA-typed electron emission display device will be now explained in more detail below.

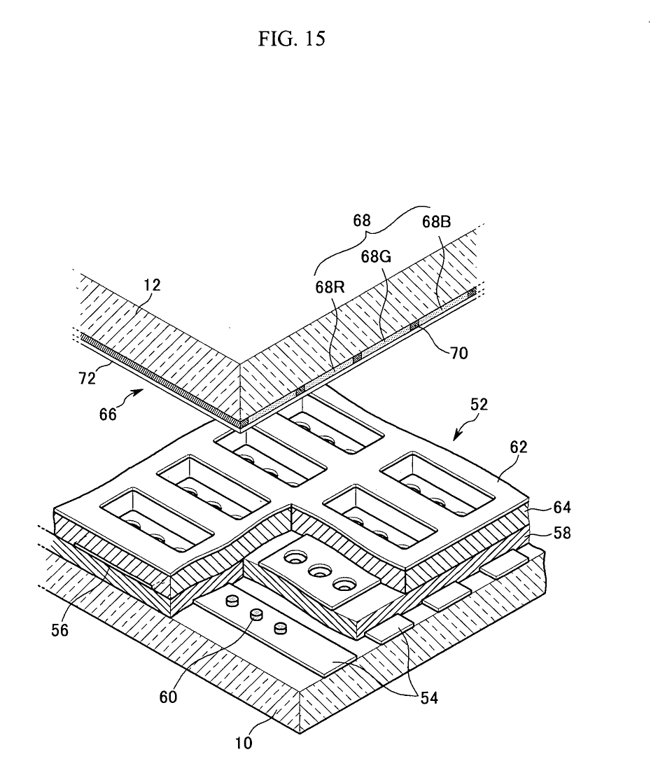

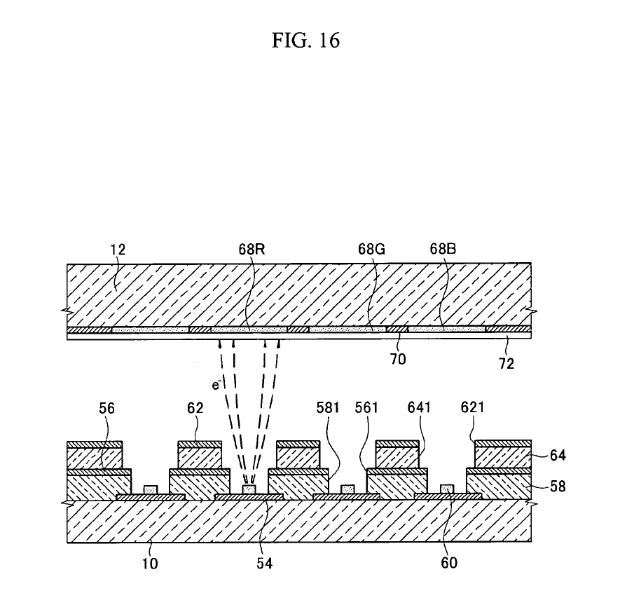

As shown in FIGS. 15 and 16, the electron emission unit 52 provided at the first substrate 10 includes cathode and gate electrodes 54 and 56 as the driving electrodes, a first insulating layer 58 disposed between the cathode and gate electrodes 54 and 56 to insulate the two electrodes from each other, electron emission regions 60 electrically connected to the cathode electrodes 54, a focusing electrode 62 placed on (or over) the gate electrodes 56, and a second insulating layer 64 disposed between the gate electrodes 56 and the focusing electrodes 62 to insulate the two electrodes from each other.

The first insulating layer 58 and the gate electrodes 56 have openings 581 and 561 formed corresponding to the respective electron emission regions 60 in order to expose the electron emission regions 60. The second insulating layer 64 and the focusing electrodes 62 have openings 541 and 561 at each sub-pixel where the cathode and the gate electrodes 54 and 56 cross each other, or at an opening formed corresponding to the respective electron emission regions 60 to expose the electron emission regions 60. In FIGS. 15 and 16, the first case is illustrated.

The electron emission regions 60 are formed with a material for emitting electrons when an electric field is applied thereto under a vacuum atmosphere. The material for emitting electrons can be a carbonaceous material and/or a nanometer-sized material. For instance, the electron emission regions 60 can be formed with carbon nanotube, graphite, graphite nanofiber, diamond, diamond-like carbon, C₆₀, silicon nanowire, or combinations thereof. Alternatively, the electron emission regions may be formed with a sharp-pointed tip structure using mainly molybdenum (Mo) and/or silicon (Si).

The light emission unit 66 provided at the second substrate 12 includes red, green, and blue phosphor layers 68R, 68G, and 68B; black layers 70 disposed between the respective phosphor layers 68 to enhance the screen contrast, and an anode electrode 72 formed on the phosphor layers 68 and the black layers 70. The anode electrode 72 may be formed with a metallic material such as aluminum. The anode electrode 72 reflects the visible rays radiated from the phosphor layers 68 to the first substrate 10 toward the second substrate 12 to thereby enhance the screen luminance.

The above-structured image display device is driven by supplying predetermined voltages to the cathode electrodes 54, the gate electrodes 56, the focusing electrode 62, and the anode electrode 72.

For instance, if a cathode electrode 54 or a gate electrode 56 (e.g., the cathode electrode 54) receives a scanning driving voltage to function as a scanning electrode, then the other electrode (e.g., the gate electrode 56) receives a data driving voltage to function as a data electrode. A focusing electrode 62 receives a voltage required for focusing the electron beams, for instance, a negative direct current voltage of 0V or of several to several tens volts. The anode electrode 72 receives a voltage required for accelerating the electron beams, for instance, a positive direct current voltage of several hundreds to several thousands volts.

Then, an electric field is formed around the electron emission regions 60 at the sub-pixels where the voltage difference between the cathode and gate electrodes 54 and 56 exceeds the threshold value, and electrons are emitted from the electron emission regions 60. The emitted electrons pass through the openings 621 of the focusing electrodes 62, thereby focusing the emitted electrons at the center of the bundle of electron beams. The focused electrons are then attracted by the high voltage applied to the anode electrode 72, thereby colliding against the phosphor layers 68 at the sub-pixels to emit light.

With the above structure, as the vacuum vessel of the above described embodiments of the present invention sufficiently endures the vacuum compression pressure even without mounting any connection structures such as spacers therein, the distance between the first and second substrates 10 and 12 can be enlarged compared to the case of the vacuum vessel using the spacers. In one embodiment, the distance between the first and second substrates 10 and 12 is established to be from 1.8 to 10 mm, or, in one embodiment, to be from 1.8 to 2.8 mm.

In case the distance between the first and second substrates 10 and 12 is 1.8 mm, a voltage of about 6.0 kV can be applied to the anode electrode 72. In case the distance between the first and second substrates 10 and 12 is 2.8 mm, a voltage of about 10 kV can be applied to the anode electrode 72. The anode electrode 72 can conduct its function only when it receives a voltage of 4 kV or more, and realize a high luminance screen when it receives a voltage from 6 to 10 kV.

By contrast, when the distance between the first and second substrates 10 and 12 exceeds 10 mm, the electron beam spot size is enlarged so that the beam focusing effect due to the anode voltage becomes negligible. Furthermore, the large spot size electron beams may excite the neighboring incorrect phosphor layers, thereby significantly deteriorating color representation rate of the screen.

As such, in the present inventive entity, it can be derive that as the distance between the first and second substrates 10 and 12 was enlarged by 1 mm, the anode voltage should be heightened by 4 kV. In a case in which the distance between the first and second substrates 10 and 12 is 2.8 mm, it is possible to apply a voltage of 10 kV to the anode electrode. That is, when the distance between the first and second substrates 10 and 12 is assumed to be Gₐ₋ₖ, the maximum voltage value Vₐ applicable to the anode electrode 72 satisfies the following condition:
Vₐ=4.0Gₐ₋ₖ−1.2 (1)
where 4.0 is a high voltage constant applicable per a unit length with a unit of V/m.

In view of the foregoing, the first and second substrates 10 and 12 are spaced apart from each other with a suitable distance so that a high voltage of 6 kV or more can be applied to the anode electrode 72. Consequently, with an image display device according to embodiments of the present invention, a high luminance display screen can be realized. Also, in embodiments of the present invention, even when a high voltage is applied to the anode electrode 72, the emission of electrons from the electron emission regions 60 at the neighboring sub-pixels that are supposed to be dark (turned off) remain dark; that is, the diode light emission is prevented (or sufficiently reduced) to thereby enhance the display image quality.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. An image display device comprising:
a vacuum vessel having electron emission regions and phosphor layers, the phosphor layers being adapted to emit light due to electrons emitted from the electron emission regions; and
a substrate traversing an interior of the vacuum vessel to partition the interior of the vacuum vessel into a plurality of regions,
wherein the substrate comprises a through-hole adapted to couple the plurality of regions with each other.

2. The image display device of claim 1, wherein the plurality of regions have respective volumes differing from each other.

3. The image display device of claim 1, wherein the plurality of regions partitioned by the substrate comprises a first region including the electron emission regions and the phosphor layers, and a second region coupled with the first region via the through-hole.

4. The image display device of claim 3, wherein the electron emission regions and the phosphor layers are spaced apart from each other with a distance from about 1.8 to about 10 mm.

5. The image display device of claim 3, further comprising an evaporative getter provided at the second region.

6. An image display device comprising:
a vacuum vessel comprising a first substrate, a second substrate placed to face a first side of the first substrate to form a first region together with the first substrate, and a reinforcing member placed to face a second side of the first substrate to form a second region together with the first substrate;
an electron emission unit formed on a surface of the first substrate; and
a light emission unit formed on a surface of the second substrate,
wherein the first substrate comprises one or more through-holes adapted to couple the first and second regions with each other.

7. The image display device of claim 6, wherein the first and second regions have respective volumes differing from each other.

8. The image display device of claim 6, wherein the second substrate and the reinforcing member are thicker than the first substrate.

9. The image display device of claim 6, further comprising an evaporative getter provided at an internal side of the reinforcing member.

10. The image display device of claim 6, wherein the reinforcing member comprises a convex central portion facing the first substrate, and a concave body portion externally surrounding the central portion and facing the first substrate.

11. The image display device of claim 10, wherein the second region has a volume larger than the first region.

12. The image display device of claim 10, further comprising an exhaust tube placed at the center of the central portion of the reinforcing member.

13. The image display device of claim 6, wherein the reinforcing member comprises a third substrate placed parallel to the first substrate and a support frame disposed between the first and third substrates and attached thereto, and the support frame has a height greater than a distance between the first and second substrates.

14. The image display device of claim 6, wherein the reinforcing member comprises a flat panel portion placed parallel to the first substrate and a skirt portion extended from a periphery of the flat panel portion to the first substrate, and the skirt portion has a height greater than a distance between the first and second substrates.

15. The image display device of claim 6, wherein the reinforcing member has a substantially flat outline, and comprises a concave portion and a sidewall formed on a surface thereof facing the first substrate.

16. The image display device of claim 15, wherein the sidewall occupies about 50% to about 90% of the entire surface area of a surface of the reinforcing member facing the first substrate.

17. The image display device of claim 15, wherein the sidewall has a width, and wherein the width of the sidewall varies along a periphery of the reinforcing member.

18. The image display device of claim 17, wherein the sidewall has a maximum width at the centers of long and short sides of the reinforcing member, and a minimum width at diagonal comers of the reinforcing member.

19. The image display device of claim 18, wherein the widths of the sidewall measured at the centers of the long and short sides of the reinforcing member are established to be about 0.2 to about 0.4 times larger than the lengths of the long and short sides of the reinforcing member, respectively.

20. The image display device of claim 15, wherein the through-hole of the first substrate is located corresponding to the sidewall of the reinforcing member, and the sidewall has a communication groove extended from a location corresponding to the through-hole to the concave portion.

21. The image display device of claim 15, wherein the sidewall comprises a partition groove for partitioning the sidewall into two or more portions in a direction proceeding toward the central portion of the reinforcing member.

22. The image display device of claim 21, wherein an outermost portion of the sidewall partitioned by the partition groove is shaped to have a looped curve along a periphery of the reinforcing member.

23. The image display device of claim 22, wherein any remaining portion of the sidewall other than the outermost portion has a height lower than the outermost portion.

24. The image display device of claim 15, wherein the reinforcing member further comprises one or more grooves formed at the concave portion, and an evaporative getter is mounted at the grooves.

25. The image display device of claim 24, wherein the evaporative getter comprises an active metal, a getter receptacle adapted to contain the active metal, a contact spring placed at the bottom of the getter receptacle, and a support connected to a lateral side of the getter receptacle, and wherein the grooves are formed with a first groove adapted to accommodate the contact spring and a second groove adapted to receive an end of the support.

26. The image display device of claim 25, wherein the end of the support is bent along an outline of the second groove, and attached to the reinforcing member using an adhesive layer.

27. The image display device of claim 6, wherein the first and second substrates are spaced apart from each other with a distance from about 1.8 to about 10 mm.

28. The image display device of claim 6, wherein the electron emission unit comprises electron emission regions having cold cathode electron sources.

29. A vacuum vessel of an image display device comprising:
a first substrate;
a second substrate placed to face a first side of the first substrate to form a first region together with the first substrate; and
a reinforcing member placed to face a second side of the first substrate to form a second region together with the first substrate,
wherein an electron emission unit is formed on a surface of the first substrate, a light emission unit is formed on a surface of the second substrate, and the first substrate comprises one or more through-holes adapted to couple the first and second regions with each other.

30. The vacuum vessel of claim 29, wherein the reinforcing member and the first substrate allow a proper amount of vacuum and spatial distance to be formed between the electron emission unit and the light emission unit without spacers between the electron emission unit and the light emission unit.
